(19) United States
(12) Patent Application Publication
(10) Pub. No.: US 2007/0285008 A1
(43) Pub. Date: Dec. 13, 2007

(54) Organic Electroluminescent Element

(76) Inventors: Shinji Matsuo, Kitakyushu-shi (JP); Hiroshi Miyazaki, Kitakyushu-shi (JP); Taishi Tsuji, Tsurugashima-shi (JP)

Correspondence Address: BIRCH STEWART KOLASCH & BIRCH, PO BOX 747, FALLS CHURCH, VA, 22040-0747, US

(21) Appl. No.: 11/660,673

(22) PCT Filed: Aug. 15, 2005
(86) PCT No.: PCT/JP05/14895

§ 371 Date: Feb. 21, 2007

(30) Foreign Application Priority Data
Aug. 23, 2004 (JP) 2004-242160

(51) Int. Cl. H01J 1/63

(52) U.S. Cl. 313/504

(57) ABSTRACT

This invention relates to an organic electroluminescent element (organic EL element) utilizing phosphorescence which shows improved luminous efficiency and driving stability and has a simple structure. The organic EL element comprises an anode, organic layers containing a hole-transporting layer, a light-emitting layer, and an electron-transporting layer, and a cathode piled one upon another on a substrate with the hole-transporting layer disposed between the light-emitting layer and the anode and the electron-transporting layer disposed between the light-emitting layer and the cathode. The light-emitting layer contains a compound represented by the following general formula (I) as a guest material and an organic metal complex containing at least one metal selected from ruthenium, rhodium, palladium, silver, rhenium, osmium, iridium, platinum, and gold as a guest material; in general formula (I), 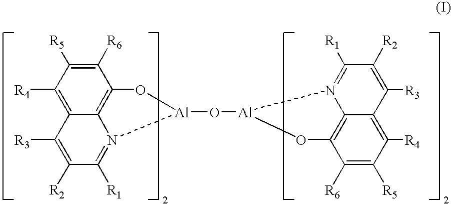
R₁-R₆ are independently hydrogen atoms, alkyl groups, aralkyl groups, alkenyl groups, cyano groups, alkoxy groups, aromatic hydrocarbon groups, or aromatic heterocyclic groups.

### FIELD OF TECHNOLOGY

This invention relates to an organic electroluminescent element (hereinafter referred to as an organic EL element) and, more particularly, to a thin-film device which emits light when an electrical field is applied to its organic light-emitting layer.

### BACKGROUND TECHNOLOGY

In the development of electroluminescent elements utilizing organic materials, the kind of electrodes was optimized for the purpose of improving the electron-injecting efficiency from the electrode and an element in which a hole-transporting layer composed of an aromatic diamine and a light-emitting layer composed of 8-hydroxyquinoline aluminum complex (hereinafter referred to as Alq3) are disposed as thin films between the electrodes was developed to bring about a noticeable improvement in luminous efficiency over the conventional elements utilizing single crystals of anthracene and the like. Following this, the developmental works of organic EL elements have been focused on their commercial applications to high-performance flat panels characterized by self luminescence and high-speed response.

In order to improve the efficiency of such organic EL elements still further, various modifications of the aforementioned basic structure of anode/hole-transporting layer/light-emitting layer/cathode have been tried by suitably adding a hole-injecting layer, an electron-injecting layer, and an electron-transporting layer. For example, the following structures are known: anode/hole-injecting layer/hole-transporting layer/light-emitting layer/cathode; anode/hole-injecting layer/light-emitting layer/electron-transporting layer/cathode; anode/hole-injecting layer/light-emitting layer/electron-transporting layer/electron-injecting layer/cathode; and anode/hole-injecting layer/hole-transporting layer/light-emitting layer/hole-blocking layer/electron-transporting layer/cathode. The hole-transporting layer has a function of transporting the holes injected from the hole-injecting layer to the light-emitting layer while the electron-transporting layer has a function of transporting the electrons injected from the cathode to the light-emitting layer. Sometimes, the hole-injecting layer is called an anode buffer layer and the electron-injecting layer is called a cathode buffer layer.

The interposition of the hole-transporting layer between the light-emitting layer and the hole-injecting layer helps to inject more holes to the light-emitting layer by application of lower electrical field and, furthermore, the electrons injected into the light-emitting layer from the cathode or from the electron-transporting layer accumulate in the light-emitting layer as the hole-transporting layer obstructs the flow of electrons. As a result, the luminous efficiency improves.

Likewise, the interposition of the electron-transporting layer between the light-emitting layer and the electron-injecting layer helps to inject more electrons into the light-emitting layer by application of lower electrical field, and, furthermore, the holes injected into the light-emitting layer from the anode or from the hole-transporting layer accumulate in the light-emitting layer as the electron-transporting layer obstructs the flow of holes. As a result, the luminous efficiency improves. A large number of organic materials conforming to the function of these layered structures have been developed.

The aforementioned element comprising the hole-transporting layer composed of an aromatic diamine and the light-emitting layer composed of Alq3 and many other elements utilize fluorescence. Now, the utilization of phosphorescence, that is, emission of light from the triplet excited state, is expected to enhance the luminous efficiency approximately three times that of the conventional elements utilizing fluorescence (singlet). To achieve this object, studies have been conducted on the use of coumarin derivatives and benzophenone derivatives in the light-emitting layer, but the result was nothing but extremely low luminance. Later, europium complexes were used in an attempt to utilize the triplet state, but failed to give high luminous efficiency.

Thereafter, the possibility of emission of red light at high efficiency by the use of a platinum complex (PtOEP and the like) was reported. Following this, it was reported that the doping of the light-emitting layer with an iridium complex [Ir(ppy)3 and the like] markedly improves the efficiency of emission of green light.

Regarding the chemical formulas of the aforementioned PtOEP, Ir(ppy)3, and the like, a reference should be made to the patent references cited below. These references additionally describe the structural formulas and abbreviations of the compounds generally used as host materials, guest materials, and hole-injecting and electron-transporting layers in organic layers.

Patent reference 1: JP5-198377 A

Patent reference 2: JP2001-313178 A

Patent reference 3: JP2002-352957 A

Patent reference 4: WO01/41512

Non-patent reference 1: Appl. Phys. Lett., Vol. 77, p. 904, 2000

One of the compounds proposed as a host material in the development of phosphorescent organic electroluminescent elements is 4,4′-bis(9-carbazolyl)biphenyl (hereinafter referred to as CBP) cited in the aforementioned patent reference 2. When used as a host material for tris(2-phenylpyridine)iridium complex [hereinafter referred to as Ir(ppy)3] which is a phosphorescent material emitting green light, CBP destroys the balanced injection of electrical charges as it has a characteristic property of facilitating the flow of holes and obstructing the flow of electrons and holes existing in excess flow out toward the electron-transporting side. As a results, the efficiency of light emission from Ir(ppy)3 drops.

As a means to solve the aforementioned problem, a hole-blocking layer is disposed between the light-emitting layer and the electron-transporting layer. The hole-blocking layer efficiently accumulates holes in the light-emitting layer and this helps to raise the probability of recombination of holes with electrons in the light-emitting layer to attain higher luminous efficiency. The hole-blocking materials currently in general use include 2,9-dimethyl-4,7-diphenyl-1,10-phenanthroline (hereinafter referred to as BCP) and (p-phenyphenolato)bis(2-methyl-8-quinolinolato-N1,O8)aluminum (hereinafter referred to as BAlq). These materials can prevent the recombination of electrons with holes in the electron-transporting layer. However, BCP lacks reliability as a hole-blocking material because of its tendency to crystallize even at room temperature and an element containing BCP is extremely short in lifetime. On the other hand, BAlq is reported to provide an element with a relatively long lifetime, but it lacks a sufficient hole-blocking ability and lowers the efficiency of light emission from Ir(ppy)3. In addition, deposition of one more layer makes the structure of an element more complex and raises the manufacturing cost.

As cited in patent reference 3, 3-phenyl-4-(1′-naphthyl)-5-phenyl-1,2,4-triazole (hereinafter referred to as TAZ) is proposed as a host material for a phosphorescent organic electroluminescent element. As this compound has a characteristic property of facilitating the flow of electrons and obstructing the flow of holes, the light-emitting range is displaced toward the side of the hole-transporting layer. In consequence, the efficiency of light emission from Ir(ppy)3 may drop depending upon the affinity of Ir(ppy)3 with the material chosen for the hole-transporting layer. For example, 4,4′-bis[N-(1-naphthyl)-N-phenylamino]biphenyl (hereinafter referred to as α-NPD) is used most frequently as a hole-transporting layer because of its excellent performance, high reliability, and long lifetime; however, it shows poor affinity with Ir(ppy)3 and transition of energy occurs from TAZ to α-NPD thereby lowering the efficiency of transition of energy to Ir(ppy)3 and dropping the luminous efficiency.

As a means to solve the aforementioned problem, a material which prohibits transition of energy from Ir(ppy)3, for example, 4,4′-bis[N,N′-(3-toluoyl)amino]-3,3′-dimethylbiphenyl (hereinafter referred to as HMTPD), is used as a hole-transporting material.

It is reported in the aforementioned non-patent reference 1 that the use of TAZ, 1,3-bis(N,N-t-butylphenyl)-1,3,4-oxazole, or BCP as a host material and Ir(ppy)3 as a guest material in the light-emitting layer, Alq3 in the electron-transporting layer, and HMTPD in the hole-transporting layer enables a phosphorescent electroluminescent element of a three-layer structure to emit light at high efficiency and this effect is particularly pronounced in a system comprising TAZ. However, HMTPD tends to crystallize easily as its glass transition temperature (hereinafter referred to as Tg) is approximately 50° C. and lacks reliability as an electroluminescent material. In consequence, there are also other problems such as extremely short lifetime of element, difficulty of commercial application, and high driving voltage.

Now, patent reference 1 discloses that a compound containing an 8-quinolinolato ring represented by (R-Q)₂Al—O—Al-(Q-R)₂ is incorporated in the layer emitting blue light and a fluorescent colorant such as perylene is used simultaneously. However, this does not teach phosphorescent luminescence. Furthermore, patent reference 4 discloses phosphorescent luminescence in which 4,4′-bis(9-carbozolyl)biphenyl (CBP) and (2-phenylbenzothiazole)iridium acetylacetonate (BTlr) are incorporated in the light-emitting layer.

### DISCLOSURE OF THE INVENTION

### Problems to be Solved by the Invention

In applying organic EL elements to display devices such as flat panel displays, it is necessary to improve the luminous efficiency and at the same time to secure the driving stability. In view of the aforementioned present conditions, an object of this invention is to provide a practically useful organic EL element which performs at high efficiency, shows long lifetime, and has a simple structure.

### Means to Solve the Problems

Accordingly, this invention relates to an organic electroluminescent element comprising an anode, organic layers containing a hole-transporting layer, a light-emitting layer, and an electron-transporting layer, and a cathode piled one upon another on a substrate with the hole-transporting layer disposed between the light-emitting layer and the anode and the electron-transporting layer disposed between the light-emitting layer and the cathode wherein the light-emitting layer contains a compound represented by the following general formula (I) as a host material and an organic metal complex containing at least one metal selected from ruthenium, rhodium, palladium, silver, rhenium, osmium, iridium, platinum, and gold as a guest material; in general formula (I), R₁-R₈ are independently hydrogen atoms, alkyl groups, aralkyl groups, alkenyl groups, cyano groups, alkoxy groups, substituted or unsubstituted aromatic hydrocarbon groups, or substituted or unsubstituted aromatic heterocyclic groups.

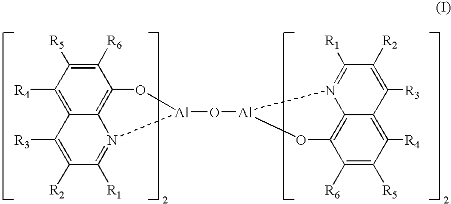

An organic EL element provided by this invention relates to an organic EL element comprising a compound represented by the aforementioned general formula (I) and a phosphorescent organic metal complex containing at least one metal selected from groups 7 to 11 of the periodic table in its light-emitting layer, that is, it relates to a so-called phosphorescent organic EL element; specifically, its light-emitting layer contains a compound represented by general formula (I) as a host material and an organic metal complex containing at least one metal selected from Ru, Rh, Pd, Ag, Re, Os, Ir, Pt, and Au as a guest material.

The host material here means a material which accounts for 50 wt % or more of the materials constituting the light-emitting layer while the guest material means a material which accounts for less than 50 wt % of the materials constituting the light-emitting layer. In an organic EL element to be provided by this invention, it is fundamentally important that the compound represented by general formula (I) in the light-emitting layer must have an excited triplet level higher in energy than the excited triplet level of the phosphorescent organic metal complex in the same light-emitting layer.

Moreover, the compound in question must be formed into a stable thin film and/or has a high Tg and is capable of transporting holes and/or electrons efficiently. Still further, the compound is required to be electrochemically and chemically stable and not form impurities during manufacture or use which would potentially become traps or quench emitted light. At the same time, in order to keep the emission of light from the phosphorescent organic complex free from the influence of the excited triplet level of the hole-transporting layer, it is also important that the compound must have an ability to inject holes so that the range of light emission is kept at a suitable distance from the interface of the hole-transporting layer.

As a material which satisfies the aforementioned requirements, a compound represented by general formula (I) is used as a host material in this invention. In general formula (I), R₁-R₆ are independently hydrogen atoms, alkyl groups, aralkyl groups, alkenyl groups, cyano groups, alkoxy groups, substituted or unsubstititued aromatic hydrocarbon groups, or substituted or unsubstituted aromatic heterocyclic groups. Preferred examples of these groups are alkyl groups of 1-6 carbon atoms (hereinafter referred to as lower alkyl groups), benzyl and phenetyl groups as aralkyl groups, lower alkenyl groups of 1-6 carbon atoms, and alkoxy groups consisting of lower alkyl groups of 1-6 carbon atoms.

Preferred examples of aromatic hydrocarbon groups are phenyl, naphthyl, acenaphtyl, and anthryl and preferred examples of aromatic heterocyclic groups are pyridyl, quinolyl, thienyl, carbazolyl, indolyl, and furyl. When these aromatic hydrocarbon groups and aromatic heterocyclic groups are substituted, the substituent groups include lower alkyl, lower alkoxy, phenoxy, benzyloxy, phenyl, and naphthyl groups.

A compound represented by general formula (I) is preferably chosen so that R₁-R₆ are hydrogen atoms, lower alkyl groups, or lower alkoxy groups.

Compounds represented by general formula (I) are known publicly in the aforementioned patent reference 1 and elsewhere and they can be used as long as they satisfy the aforementioned definition of R₁-R₆. These compounds can be synthesized by the complex-forming reaction of a metal salt with a compound represented by formula (II). For example, the synthesis is carried out according to the method described by Y. Kushi et al. (J. Amer. Chem. Soc., Vol. 92, p. 91, 1970). The groups R₁-R₆ in formula (II) correspond to the groups R₁-R₆ in general formula (I).

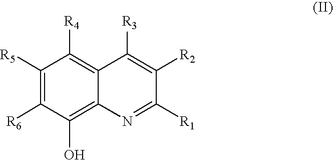

The compounds satisfying general formula (I) are listed below in chemical formula, but they are not limited to these examples. The number in parenthesis at the end of the chemical formula is used in common with the experimental examples.

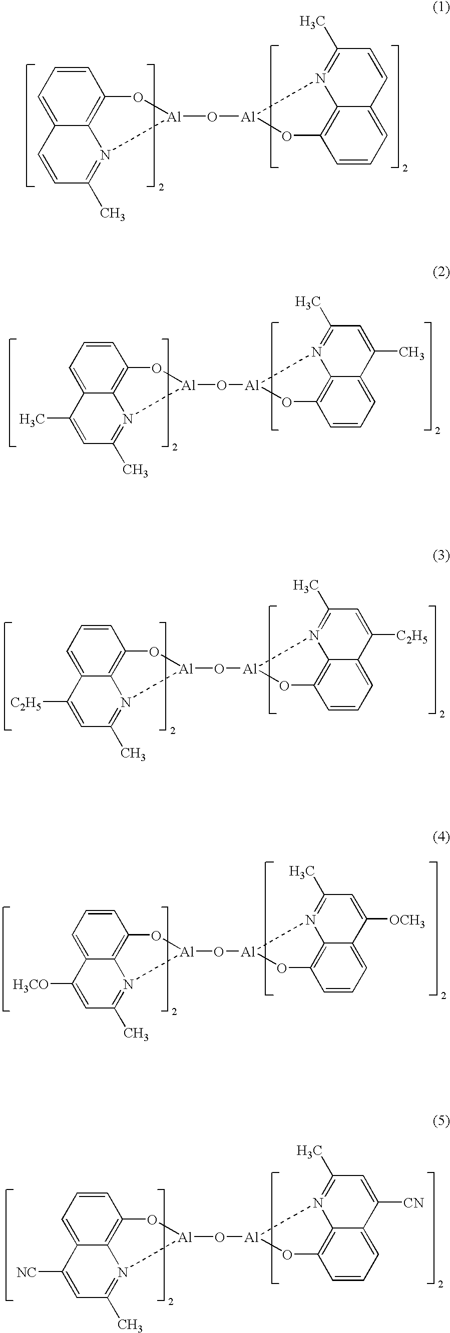

A guest material in the light-emitting layer comprises an organic metal complex containing at least one metal selected from ruthenium, rhodium, palladium, silver, rhenium, osmium, iridium, platinum, and gold. Organic metal complexes of this kind are known publicly in the aforementioned patent references and a suitable compound may be selected from such known compounds and used.

Preferable organic metal complexes are those having a noble metal at the center such as Ir(ppy)3 (formula A), complexes such as Ir(bt)2.acac3 (formula B), and complexes such as PtOEt3 (formula C). Concrete examples of these complexes are shown below, but the organic metal complexes suitable for this invention are not limited to these examples.

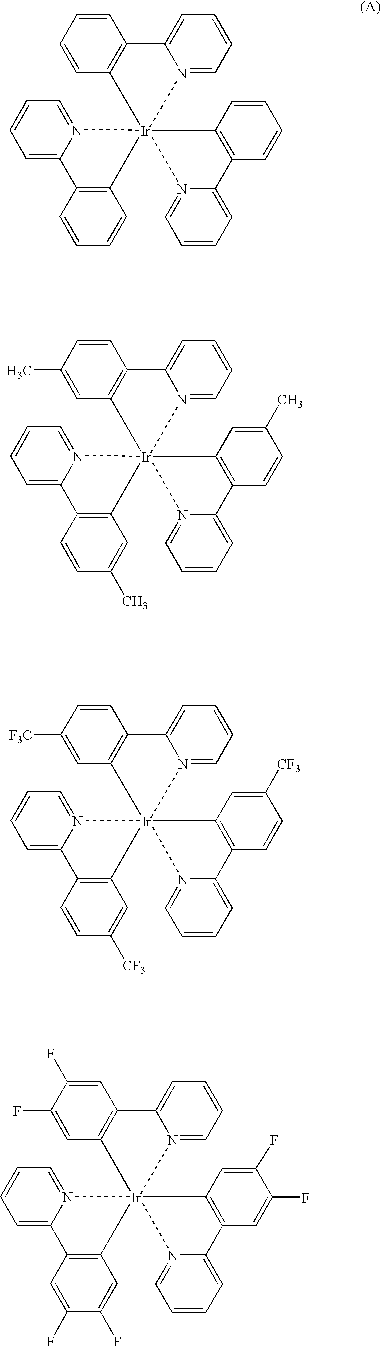

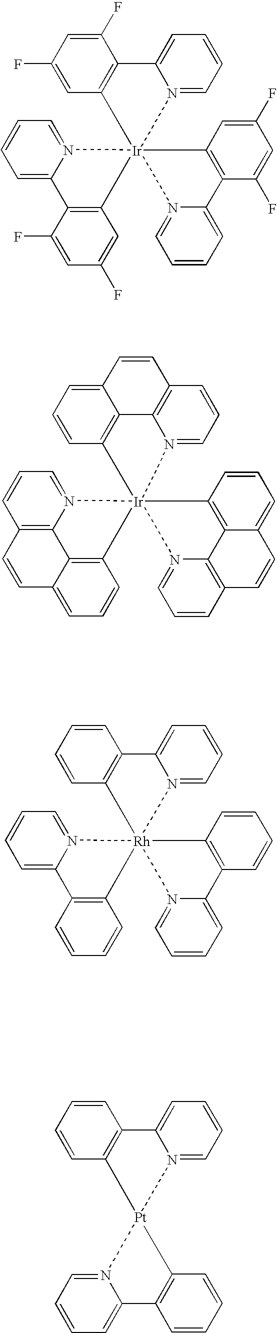

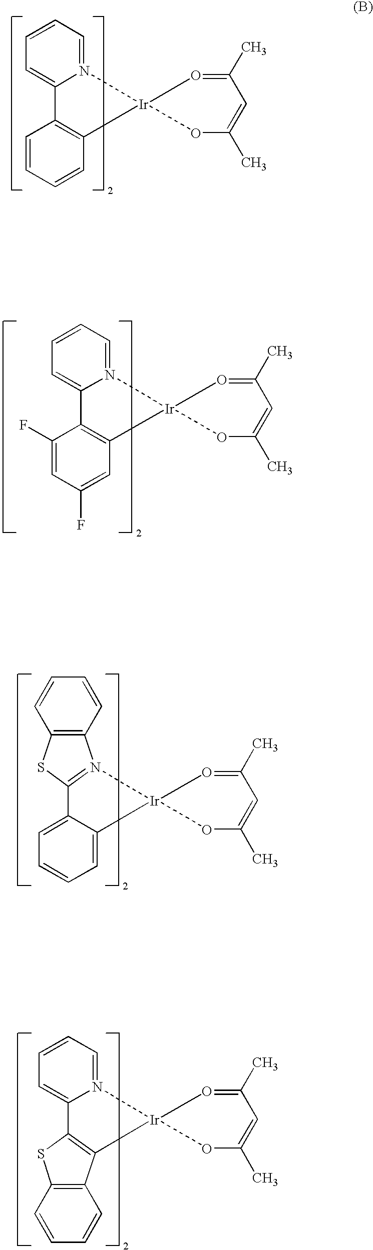

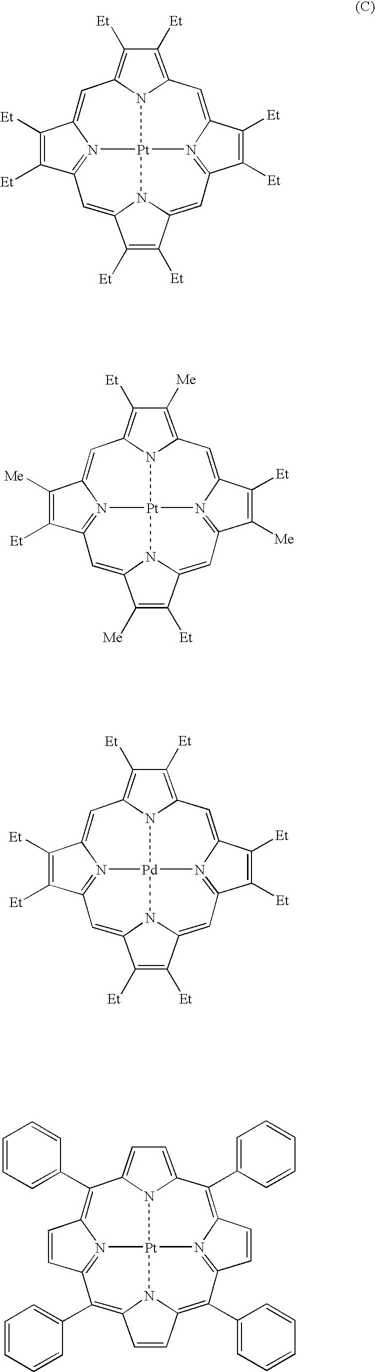

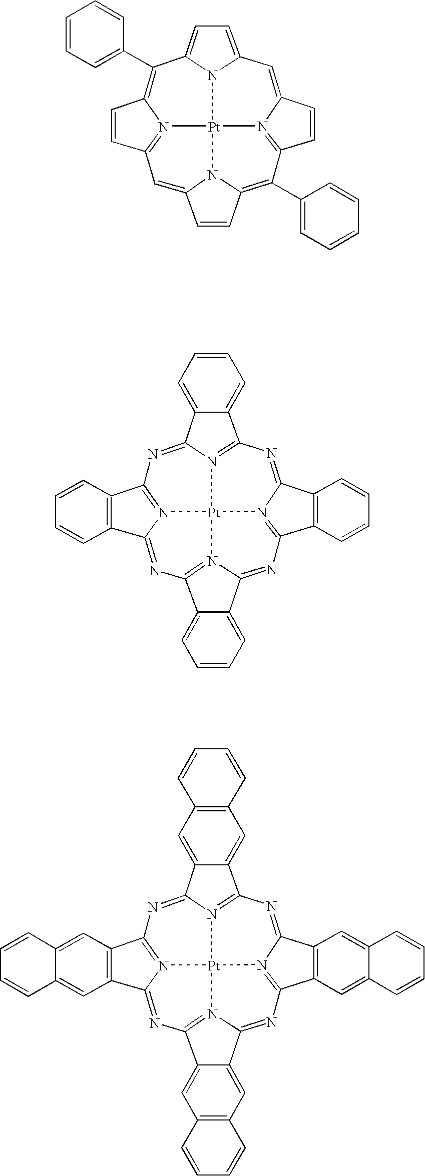

The host material to be used in the light-emitting layer according to this invention allows electrons and holes to flow roughly evenly so that emission of light occurs in the center of the light-emitting layer. In the case of TAZ, emission of light occurs on the side of the hole-transporting layer thereby causing transition of energy to occur to the hole-transporting layer and lowering the luminous efficiency. On the other hand, in the case of CBP, emission of light occurs on the side of the electron-transporting layer thereby causing transition of energy to occur to the electron-transporting layer and lowering the luminous efficiency. This is not the case with the host material to be used in this invention and highly reliable materials can be used together, for example, α-NPD in the hole-transporting layer and Alq3 in the electron-transporting layer.

In particular, in the case where red light is emitted using CBP as a host material and bis(2-(2′-benzo[4,5-α]thienyl)pyridinato-N,C3′)iridium(acetylacetonate) complex [hereinafter referred to as btp₂Ir(acac)] as a guest material, a technique of providing a hole-blocking layer composed of BCP or the like is known to make up for the CBP's shortcoming of facilitating the flow of holes. However, the use of a combination of materials specified by this invention can give a comparable performance in the absence of a hole-transporting layer.

### BRIEF DESCRIPTION OF THE DRAWING

FIG. 1: A schematic cross section of an example of organic electroluminescent element.

### PREFERRED EMBODIMENTS OF THE INVENTION

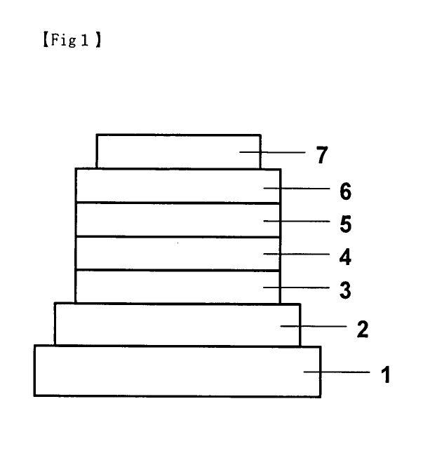

An organic El element of this invention will be described with reference to the drawing. FIG. 1 schematically illustrates the cross section of a structure generally used for an organic EL element of this invention. In FIG. 1, a substrate is designated as 1, an anode as 2, a hole-injecting layer as 3, a hole-transporting layer as 4, a light-emitting layer as 5, an electron-transporting layer as 6, and a cathode as 7. An organic EL element of this invention has essential layers comprising a substrate, an anode, a hole-transporting layer, a light-emitting layer, an electron-transporting layer, and a cathode and non-essential layers such as a hole-injecting layer can be omitted and, if necessary, other layers may be added. However, an organic EL element of this invention does not require a hole-blocking layer. Omission of a hole-blocking layer simplifies the layered structure and offers advantages in manufacture and performance.

The substrate 1 supports an organic EL element and is made from a quartz or glass plate, a metal plate or foil, or a plastic film or sheet. In particular, glass plates and transparent sheets of synthetic resins such as polyester, polymethacrylate, polycarbonate, and polystyrene are desirable. When a synthetic resin is used for a substrate, it is necessary to take the gas barrier property of the resin into consideration. When the gas barrier property of the substrate is too poor, there is an undesirable possibility of the air passing through a substrate to degrade an organic EL element. One of the remedial methods is to provide a dense silicon oxide film on at least one side of the synthetic resin substrate to secure the necessary gas barrier property.

The anode 2 is provided on the substrate 1 and plays a role of injecting holes into the hole-transporting layer. The anode is usually constructed of a metal such as aluminum, gold, silver, nickel, palladium and platinum, a metal oxide such as oxide of indium and/or tin, a metal halide such as copper iodide, carbon black, and conductive polymers such as poly(3-methylthiophene), polypyrrole, and polyaniline. The anode is usually formed by a technique such as sputtering and vacuum deposition. When metals such as silver, copper iodide, carbon black, conductive metal oxides and conductive polymers are respectively available as fine particles, the particles may be dispersed in a solution of a binder resin and applied to the substrate 1 to form the anode 2. Moreover, in the case of a conductive polymer, it is possible to form the anode 2 by forming a thin film of the polymer directly on the substrate 1 by electrolytic polymerization of the corresponding monomer or by coating the substrate 1 with the conductive polymer. The anode 2 may also be formed by laminating different materials. The anode varies in thickness with the requirement for transparency. Where transparency is required, it is preferable to keep the transmittance of visible light usually at 60% or more, preferably at 80% or more. In this case, the thickness is usually 5-1000 nm, preferably 10-500 nm. Where opaqueness is permitted, the anode 2 may be the same as the substrate 1. It is possible to laminate a different conductive material on the aforementioned anode 2.

The hole-transporting layer 4 is provided on the anode 2. The hole-injecting layer 3 may be disposed between the anode and the hole-transporting layer. The material selected for the hole-transporting layer must inject holes from the anode efficiently and transport the injected holes efficiently. To satisfy this requirement, the material in question must have a low ionization potential, be highly transparent against visible light, show high hole mobility, show excellent stability, and rarely generates impurities during manufacture or use that become traps. Still more, as the hole-transporting layer exists in contact with the light-emitting layer 5, it must not quench the light from the light-emitting layer nor form exciplexes with the light-emitting layer to lower the efficiency. Besides the aforementioned general requirements, heat resistance is required where application to vehicular displays is considered. Hence, the material preferably has a Tg of 85° C. or above.

A known triarylamine dimer such as α-NPD may be used as a hole-transporting material in an organic El element according to this invention.

If necessary, the triarylamine dimer can be used together with other compounds known as hole-transporting materials. For example, such hole-transporting materials include aromatic diamines containing two tertiary amines whose nitrogen atoms are substituted with two or more aromatic condensed rings, aromatic amines of a starburst structure such as 4,4′,4″-tris(1-naphthylphenylamino)triphenylamine, an aromatic amine consisting of a tetramer of triphenylamine and spiro compounds such as 2,2′,7,7′-tetrakis(diphenylamino)-9,9′-spirobifluorene. These compounds may be used singly or as a mixture.

In addition to the aforementioned compounds, the materials useful for the hole-transporting layer include polymeric materials such as polyvinylcarbazole, polyvinyltriphenylamine, and polyaryleneethersulfones containing tetraphenylbenzidine.

When the coating process is used in forming the hole-transporting layer, a coating solution is prepared by mixing one kind or more of hole-transporting materials and, if necessary, binder resins that do not become traps of holes and additives such as improvers of coating properties, the solution is applied to the anode 2 by a process such as spin coating and the solution is dried to form the hole-transporting layer 4. The binder resins here include polycarbonate, polyarylate, and polyester. Addition of a binder resin in a large amount lowers the hole mobility and it is preferably kept at a low level, usually below 50 wt %.

When the vacuum deposition process is used in forming the hole-transporting layer, the selected hole-transporting material is introduced to a crucible placed in a vacuum container, the container is evacuated to 1×10⁻⁴ Pa or so by a suitable vacuum pump, the crucible is heated to evaporate the hole-transporting material, and the hole-transporting layer 4 is formed on the substrate which is placed opposite the crucible and on which the anode has been formed. The thickness of the hole-transporting layer 4 is usually 5-300 nm, preferably 10-100 nm. The vacuum deposition process is generally used to form a thin film of this thickness uniformly.

The light-emitting layer 5 is provided on the hole-transporting layer 4. The light-emitting layer 5 comprises a compound represented by the aforementioned general formula (I) and an organic metal complex containing a metal selected from groups 7 to 10 of the periodic table and, on application of an electrical field between the electrodes, the holes injected from the anode and migrating through the hole-transporting layer recombine with the electrons injected from the cathode and migrating through the electron-transporting layer 7 (or the hole-blocking layer 6) to excite the light-emitting layer thereby causing intense luminescence. The light-emitting layer 5 may contain other components, for example, non-essential host materials and fluorescent colorants to the extent that they do not damage the performance of this invention.

The content of the aforementioned organic metal complex in the light-emitting layer is preferably in the range of 0.1-30 wt %. A content of less than 0.1 wt % cannot contribute to improvement of the luminous efficiency of an element while a content in excess of 30 wt % causes quenching of light due to change in concentration caused by dimerization of the molecules of the organic metal complex and results in lowering of the luminous efficiency. In the conventional elements utilizing fluorescence (singlet), it is a desirable tendency for an organic metal complex to be in an amount somewhat larger than that of a fluorescent colorant (dopant) contained in the light-emitting layer. The organic metal complex may be contained partially or distributed nonuniformly in the direction of the film thickness in the light-emitting layer.

The thickness of the light-emitting layer 5 is usually 10-200 nm, preferably 20-100 nm. The light-emitting layer 5 is formed in thin film in the same way as the hole-transporting layer 4.

In order to improve further the luminous efficiency of an element, the electron-transporting layer 6 is disposed between the light-emitting layer 5 and the cathode 5. The electron-transporting layer 6 is made from a compound which is capable of efficiently transporting the electrons injected from the cathode toward the light-emitting layer 5 upon application of an electrical field between the electrodes. An electron-transporting compound to be used in the electron-transporting layer 6 must be a compound which efficiently injects electrons from the cathode 7, shows high hole mobility, and efficiently transports the injected electrons.

The electron-transporting materials satisfying the aforementioned conditions include metal complexes such as Alq3, 10-hydroxybenzo[h]quinoline metal complexes, oxadiazole derivatives, distyrylbiphenyl derivatives, silole derivatives, 3- or 5-hydroxyflavone metal complexes, trisbenzimidazolylbenzene, quinoxaline compounds, phenanthroline derivatives, 2-t-butyl-9,10-N,N′-dicyanoanthraquinonediimine, n-type hydrogenated amorphous silicon carbide, n-type zinc sulfide, and n-type zinc selenide. The thickness of the electron-transporting layer 6 is usually 5-200 nm, preferably 10-100 nm.

The electron-transporting layer 6 is formed on the light-emitting layer 6 by the coating or vacuum deposition process as in the case of the hole-transporting layer 4. The vacuum deposition process is normally used.

The interposition of the hole-injecting layer 3 between the hole-transporting layer 4 and the anode 2 is also practiced for the purpose of improving the hole-injecting efficiency and the adhesive strength of the organic layer as a whole to the anode. The interposition of the hole-injecting layer 3 is effective for lowering the initial driving voltage of an element and at the same time suppressing a rise in voltage when an element is driven continuously at constant current density. A material to be used for the hole-injecting layer must satisfy the following requirements; it adheres closely to the anode, it can be formed into a thin film uniformly, and it is thermally stable, that is, it has a melting point of 300° C. or above and a glass transition temperature of 100° C. or above. Furthermore, the material in question must have a low ionization potential, facilitate the injection of holes from the anode, and show high hole mobility.

The materials reported to be capable of attaining this object include phthalocyanine compounds such as copper phthalocyanine, organic compounds such as polyaniline and polythiophene, sputtered carbon membranes (Synth. Met., Vol. 91, p. 73, 1997), and oxides of metals such as vanadium, ruthenium, and molybdenum. The hole-injecting layer can be formed in thin film as in the case of the hole-transporting layer and, further, the processes such as sputtering, electron beam deposition, and plasma CVD can be used in the case of inorganic materials. The thickness of the anode buffer layer 3 formed in the aforementioned manner is usually 3-100 nm, preferably 5-50 nm.

The cathode 7 plays a role of injecting electrons into the light-emitting layer 5. A material to be used for the cathode may be the same as that used for the aforementioned anode 2, but a metal with low work function is used preferably as it efficiently injects electrons. Examples of such metals are tin, magnesium, indium, calcium, aluminum, silver, and their alloys. Concrete examples are electrodes made from alloys of low work function such as magnesium-silver alloy, magnesium-indium alloy, and aluminum-lithium alloy.

The thickness of the anode 7 is usually the same as that of the anode 2. To protect a cathode made from a metal of low work function, a layer of a metal of high work function which is stable in the air is laminated to the cathode thereby increasing the stability of an element. The metals suitable for attaining this object include aluminum, silver, copper, nickel, chromium, gold, and platinum.

Furthermore, the interposition of an ultrathin insulating film (0.1-5 nm) of LiF, MgF₂, Li₂O, and the like between the cathode and the electron-transporting layer provides another effective means to improve the efficiency of an element.

It is possible to obtain an element having a structure which is the reverse of the structure shown in FIG. 1 by piling the cathode 7, the electron-transporting layer 6, the light-emitting layer 5, the hole-transporting layer 4, and the anode 2 one upon another in this order on the substrate 1. As was described earlier, it is also possible to place an organic EL element of this invention between two substrates at least one of which is highly transparent. In this case, it is also possible to add or omit layers if necessary.

An organic EL element provided by this invention can be applied to a single element, an element having a structure arranged in array, or an element having a structure with the anode and the cathode arranged in X-Y matrix. An organic EL element obtained according to this invention by incorporating a compound of specified skeleton and a phosphorescent metal complex in its light-emitting layer shows marked improvements in luminous efficiency and driving stability compared with the conventional elements utilizing emission of light from the singlet state and is capable of performing excellently in (applications to full-color or multicolor panels.

This invention will be described in detail below with reference to Synthetic Examples and Examples, but it will not be limited to the description in these examples unless it exceeds the substance of this invention.

### SUPPLEMENTARY EXAMPLE 1

Bis(2-methyl-8-hydroxyquinolinolato)aluminum(III)-β-oxo-bis(2-methyl-8-hydroxyquinolinolato)aluminum(III) (Compound 1), TAZ, or BAlq was deposited on a glass substrate at a degree of vacuum of 4.0×10⁻⁴ Pa to a film thickness of 100 nm at a rate of deposition of 1.0 Å/s. Each specimen was left standing in the air at room temperature and the time until start of crystallization was measured to examine the stability of thin film. The results are shown in Table 1.

TABLE 1

| | Number of days until start of |
|---|---|
| | crystallization |
| Compound 1 | 30 days or more |
| TAZ | 2 days or less |
| BAlq | 20 days or so |

### EXAMPLE 1

Copper phthalocyanine (CuPC), α-NPD, and Alq3 were used respectively for forming a hole-injecting layer, a hole-transporting layer, and an electron-transporting layer by vacuum-depositing one compound upon another in thin film at a degree of vacuum of 5.0×10⁻⁴ Pa on a glass substrate on which a 110 nm-thick ITO anode had been formed. First, CuPC was deposited on the ITO anode at a rate of 3.0 Å/s to a film thickness of 25 nm to form a hole-injecting layer. On this hole-injecting layer was deposited α-NPD at a rate of 3.0 Å/s to a film thickness of 55 nm to form a hole-transporting layer. Å

Following this, a light-emitting layer was formed by co-vacuum-depositing Compound 1 and btp₂Ir(acac) on the hole-transporting layer from different evaporation sources to a thickness of 47.5 nm. The concentration of btp₂Ir(acac) at this point was 7.0%. Then, Alq3 was deposited at a rate of 3.0 Å/s to a thickness of 30 nm to form an electron-transporting layer.

Further, an electron-injecting layer was formed on the electron-transporting layer by vacuum-depositing lithium oxide (Li₂O) at a rate of 0.1 Å/s to a thickness of 1 nm. Finally, aluminum as an electrode was vacuum-deposited on the electron-injecting layer at a rate of 10 Å/s to a thickness of 100 nm to give an organic EL element.

### COMPARATIVE EXAMPLE 1

An organic EL element was prepared as in Example 1 with the exception of using BAlq as a host material in the light-emitting layer.

The organic EL elements obtained in Example 1 and Comparative Example 1 were submitted to the storage test at 100° C. to evaluate their luminous characteristics. The changes in chromaticity, luminance, and voltage with the passage of time when driven at 5.5 mA/cm² are shown in Table 2 for Example 1 and in Table 3 for Comparative Example 1.

TABLE 2

| Time | | | | |
|---|---|---|---|---|
| elapsed | Chromaticity coordinates | | Luminance | Driving voltage |
| (hours) | CIEx | CIEy | (cd/m²) | (V) |
| 0 | 0.682 | 0.318 | 301 | 8.54 |
| 83 | 0.680 | 0.319 | 315 | 8.57 |
| 167 | 0.682 | 0.318 | 309 | 8.58 |
| 315 | 0.680 | 0.318 | 321 | 8.57 |
| 416 | 0.681 | 0.318 | 326 | 8.59 |
| 550 | 0.680 | 0.319 | 330 | 8.61 |

TABLE 3

| Time | | | | |
|---|---|---|---|---|
| elapsed | Chromaticity coordinates | | Luminance | Driving voltage |
| (hours) | CIEx | CIEy | (cd/m²) | (V) |
| 0 | 0.678 | 0.321 | 337 | 9.20 |
| 63 | 0.677 | 0.323 | 269 | 6.93 |
| 159 | 0.576 | 0.386 | 66 | 6.51 |
| 324 | 0.528 | 0.416 | 63 | 6.79 |
| 500 | 0.525 | 0.423 | 65 | 6.92 |

When the organic EL element obtained in Example 1 was stored at 100° C. for 500 hours, practically no change was observed in the initial characteristics and chromaticity. To the contrary, when the organic EL element obtained in Comparative Example 1 was submitted to the similar storage test at 100° C., the chromaticity dropped by 80% and the color of emitted light changed from red to yellow after 160 hours.

No Tg is observed for Compound 1 as it does not have a melting point like Alq3. However, Compound 1 decomposes at 414° C. and this suggests that a thin film formed from this material would show an excellent stability at high temperature. On the other hand, BAlq used in the comparative example shows a melting point of 233° C. and a Tg of 99° C. and seems to have suffered the aforementioned degradation as crystallization progressed in the element during the storage test at 100° C.

### INDUSTRIAL APPLICABILITY

According to this invention, an organic EL element comprising a light-emitting layer containing a phosphorescent organic metal guest material can be provided with excellent heat stability and prolonged driving life with sustained luminous characteristics by using a binuclear aluminum chelate of a specific structure represented by the aforementioned general formula (I) as a host material in the light-emitting layer according to this invention. Thus, organic EL elements obtained according to this invention are of high technical value because of their potential applicability to flat panel displays (for example, office computers and wall-hanging television sets), vehicular display devices, cell phone displays, light sources utilizing a characteristic of a planar luminous body (for example, light source of copiers and backlight source of liquid crystal displays and instruments), display boards, and marking lamps.

What is claimed is:

1. An organic electroluminescent element comprising an anode, organic layers containing a hole-transporting layer, a light-emitting layer, and an electron-transporting layer, and a cathode piled one upon another on a substrate with the hole-transporting layer disposed between the light-emitting layer and the anode and the electron-transporting layer disposed between the light-emitting layer and the cathode wherein the light-emitting layer contains a compound represented by the following general formula (I) as a host material and an organic metal complex containing at least one metal selected from ruthenium, rhodium, palladium, silver, rhenium, osmium, iridium, platinum, and gold as a guest material; 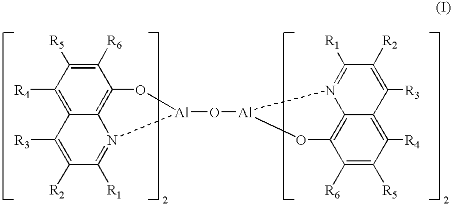
wherein, R₁-R₆ are independently hydrogen atoms, alkyl groups, aralkyl groups, alkenyl groups, cyano groups, alkoxy groups, substituted or unsubstituted aromatic hydrocarbon groups, or substituted or unsubstituted aromatic heterocyclic groups.

2. An organic electroluminescent element as described in claim 1 wherein a hole-injecting layer is disposed between the anode and the hole-transporting layer.

3. An organic electroluminescent element as described in claim 1 or 2 wherein an electron-injecting layer is disposed between the cathode and the electron-transporting layer.
